(19) United States
(12) Patent Application Publication
(10) Pub. No.: US 2014/0065640 A1
(43) Pub. Date: Mar. 6, 2014

(54) Interferometric Detection Using Nanoparticles

(71) Applicants: Molecular Sensing, Inc., (US); Vanderbilt University, Nashville, TN (US)

(72) Inventors: Scot Weinberger, Montara, CA (US); William E. Rich, Whitefish, MT (US); Stephen Dotson, Lubbock, TX (US); Darryl J. Bornhop, Montara, CA (US)

(73) Assignees: Vanderbilt University, Nashville, TN (US); Molecular Sensing, Inc., Montara, CA (US)

(21) Appl. No.: 13/886,108

(22) Filed: May 2, 2013

Related U.S. Application Data
(63) Continuation of application No. PCT/US2011/001858, filed on Nov. 2, 2011.
(60) Provisional application No. 61/409,368, filed on Nov. 2, 2010.

(51) Int. Cl. G01N 21/47

(52) U.S. Cl. CPC G01N 21/47
USPC 435/7.2; 436/501; 435/7.1; 435/288.7; 422/69

(57) ABSTRACT

This invention provides methods and systems for detecting interaction between members of a binding pair. The method involves associating one member of the binding pair with a nanoparticle and detecting the interaction between the two molecules by back-scattering interferometry.

### CROSS-REFERENCE TO RELATED APPLICATIONS

This application claims the benefit of the priority date of U.S. provisional patent application 61/409,368, filed Nov. 2, 2010, incorporated herein by reference in its entirety.

### STATEMENT AS TO FEDERALLY SPONSORED RESEARCH

None.

### BACKGROUND OF THE INVENTION

Back-scattering interferometry (“BSI”) is a method useful for detecting interactions between molecules in a sample. A version of the method was described in U.S. Pat. No. 5,325,170 (Bornhop et al., Jun. 28, 1994). The method described there involves directing a laser beam onto a channel to produce back-scattered light in the form of an interference fringe pattern. The form and location of the fringe pattern is a function of the refractive index of the liquid being interrogated. Binding events between molecules in the fluid, such as ligand-receptor interactions, change the refractive index of the fluid and result in a shift in the location of the fringe pattern. U.S. Pat. No. 6,381,025 (Bornhop et al., Apr. 30, 2002) describes a method for performing back-scattering interferometry in which a channel is disposed in a micro-fabricated substrate. U.S. Pat. No. 6,809,828 (Bornhop et al., Oct. 26, 2004) describes a chip for back-scattering interferometry in which the substrate has a channel taking the form of a rectangle. U.S. Pat. No. 7,130,060 (Bornhop et al., Oct. 31, 2005) describes a method for determining absolute refractive index using back-scattering interferometry in which light is directed at a capillary tube and refractive index is determined as a function of the angle at which there is a marked change in intensity. Bornhop et al., Science, 317:1732, Sep. 21, 2007, describes free-solution, label-free molecular interactions investigated by back-scattering interferometry. U.S. patent publication 2009-0185190 (Weinberger et al., Jul. 23, 2009) describes an interferometer for detecting analyte in a microfluidic chip. The device maintains a stable temperature at the chip with variation of no more than 5 millidegrees C. and/or no more than 20 millidegrees C. in the medium through which the optical train travels from a source of coherent light to the chip when ambient temperature changes up to 5 degrees centigrade over five minutes. The device comprises thermally isolated compartments that hinder heat transfer from one part of the instrument to another and temperature regulators that regulate temperature of the chip and the optical train compartment as a function of temperatures at the chip, in the compartment, and ambient.

### SUMMARY OF THE INVENTION

In one aspect this invention provides a method of detecting an analyte in a solution comprising detecting interaction between the analyte and a binding partner by back-scattering interferometry (BSI), wherein the binding partner is associated with a nanoparticle (“binding partner-nanoparticle combination”). In one embodiment the analyte and the binding partner-nanoparticle combination are in free-solution. In another embodiment the analyte is immobilized on a wall of an assay compartment. In another embodiment the binding partner-nanoparticle combination is immobilized on a wall of an assay compartment. In another embodiment the method comprises an end-point assay. In another embodiment the method comprises a kinetic assay. In another embodiment back-scattering interferometry uses a laser emitting light having a wavelength in the visible or near-infrared range, and the nanoparticle in its longest dimension has a length between one-tenth and one-half of the wavelength. In another embodiment wherein the laser is a helium neon (HeNe) laser, VCSEL or LED laser. In another embodiment the laser emits light at about 543 nm, about 632.8 nm, about 1.15 μm, about 1.52 μm, or about 3.39 μm. In another embodiment the nanoparticle, in its longest dimension, has a length between 1 nm and 1 micron. In another embodiment the nanoparticle, in its longest dimension, has a length between about 60 nm and about 300 nm. In another embodiment the nanoparticle is spheroid. In another embodiment the nanoparticle is discoid. In another embodiment the nanoparticle comprises a metal, a ceramic, a polymer, or a macromolecular structure. In another embodiment the nanoparticle comprises a rare earth metal. In another embodiment the metal is silver or gold. In another embodiment the nanoparticle comprises silica. In another embodiment the nanoparticle comprises latex. In another embodiment the nanoparticle is selected from a liposome, a lipoparticle, an amphipol, a nanodiscs and a fluorinated surfactant. In another embodiment the nanoparticle comprises a small unilamellar vesicle. In another embodiment the nanoparticle comprises a large unilamellar vesicle. In another embodiment the binding partner is associated with a surface of the nanoparticle. In another embodiment the binding partner is associated within the nanoparticle. In another embodiment the binding partner is covalently bound to the nanoparticle. In another embodiment the binding partner is non-covalently bound to the nanoparticle. In another embodiment the interaction is between antibody-antigen, protein-protein, small molecule-small molecule; small molecule-protein, drug-receptor; enzyme-substrate; protein-DNA; protein-aptamer; DNA-DNA; RNA-RNA; DNA-RNA; protein-RNA; small molecule-nucleic acid; biomolecule-molecular imprint; biomolecule-protein mimetic; biomolecule-antibody derivatives; lectin-carbohydrate; biomolecule-carbohydrate; small molecule-cell membrane-bound protein; antibody-cell membrane-bound protein; or enzyme-substrate. In another embodiment the analyte comprises a small molecule, a nucleic acid, a polypeptide, a carbohydrate, a lipid, protein, glycoprotein, lipoprotein, DNA, RNA, DNA-protein construct or an RNA-protein construct. In another embodiment the binding partner comprises a small molecule, a nucleic acid, a polypeptide, a carbohydrate, a lipid, protein, glycoprotein, lipoprotein, DNA, RNA, DNA-protein construct or an RNA-protein construct. In another embodiment the binding partner comprises a membrane protein, e.g., associated with lipid comprised in the nanoparticle. In another embodiment the concentration of the analyte is less than 1.0×10⁻⁵ M, less than 1.0×10⁻⁶ M, less than 1.0×10⁻⁷ M, less than 1.0×10⁻⁸ M, less than 1.0×10⁻⁹ M, less than 1.0×10⁻¹⁰ M, less than 1.0×10⁻¹¹ M or less than 1.0×10⁻¹² M. In another embodiment the nanoparticle is not a liposome or does not comprise a lipid.

In another aspect this invention provides a method comprising: a) providing an instrument comprising: i) a coherent light source; ii) a container comprising a compartment comprising an interrogation volume positioned to be interrogated by coherent light from the coherent light source, wherein the interrogation volume is configured to generate back-scattered light comprising an interference fringe pattern when interrogated by the coherent light source; and iii) a detector to detect the back-scattered light; b) introducing an analyte and a binding partner into the compartment in free solution, wherein the binding partner is associated with a nanoparticle; c) interrogating the compartment with coherent light from the coherent light source; and d) detecting interaction between the analyte and the binding partner based on the generated interference fringe pattern. In one embodiment detecting binding comprises detecting back-scattered light from the channel, converting the detected back-scattered light into a measure of refractive index and correlating the measure with a measure indicating binding.

In another aspect this invention provides a method comprising: a) providing an instrument comprising: i) a coherent light source; ii) a container comprising a compartment comprising an interrogation volume positioned to be interrogated by coherent light from the coherent light source, wherein a binding partner is immobilized on a wall of the compartment and wherein the interrogation volume is configured to generate back-scattered light comprising an interference fringe pattern when interrogated by the coherent light source; and iii) a detector to detect the back-scattered light; b) introducing an analyte associated with a nanoparticle into the compartment; c) interrogating the compartment with coherent light from the coherent light source; and d) detecting interaction between the analyte and the binding partner based on the generated interference fringe pattern. In one embodiment detecting binding comprises detecting back-scattered light from the channel, converting the detected back-scattered light into a measure of refractive index and correlating the measure with a measure indicating binding. In another embodiment the analyte is bound to the nanoparticle.

In another aspect this invention provides a method comprising: a) providing an instrument comprising: i) a coherent light source; ii) a container comprising a compartment comprising an interrogation volume positioned to be interrogated by coherent light from the coherent light source, wherein a binding partner associated with a nanoparticle is immobilized on a wall of the compartment and wherein the interrogation volume is configured to generate back-scattered light comprising an interference fringe pattern when interrogated by the coherent light source; and iii) a detector to detect the back-scattered light; b) introducing an analyte into the compartment; c) interrogating the compartment with coherent light from the coherent light source; and d) detecting interaction between the analyte and the binding partner based on the generated interference fringe pattern. In one embodiment detecting binding comprises detecting back-scattered light from the channel, converting the detected back-scattered light into a measure of refractive index and correlating the measure with a measure indicating binding.

In another aspect this invention provides a method comprising: a) providing an instrument comprising: i) a coherent light source; ii) a container comprising a compartment comprising an interrogation volume positioned to be interrogated by coherent light from the coherent light source, wherein the interrogation volume is configured to generate back-scattered light comprising an interference fringe pattern when interrogated by the coherent light source; and iii) a detector to detect the back-scattered light; b) introducing an analyte into the compartment; c) introducing a binding partner for the analyte into the compartment; wherein the binding partner is associated with a nanoparticle; d) introducing a test agent into the compartment; e) interrogating the compartment with coherent light from the coherent light source; and f) determining whether the test agent alters binding between the analyte and the binding partner based on the generated interference fringe pattern. In one aspect detecting binding comprises detecting back-scattered light from the channel, converting the detected back-scattered light into a measure of refractive index and correlating the measure with a measure indicating binding.

In another aspect this invention provides an instrument comprising: a) a coherent light source; b) a container comprising a compartment comprising an interrogation volume positioned to be interrogated by coherent light from the coherent light source, wherein the interrogation volume is configured to generate back-scattered light comprising an interference fringe pattern when interrogated by the coherent light source, and wherein the compartment comprises a solution comprising a binding partner associated with a nanoparticle; and c) a detector to detect the back-scattered light. In one embodiment the instrument further comprises: d) a signal analyzer configured to analyze a signal provided by the detector. In another embodiment the coherent light source is a HeNe laser, VCSEL or LED laser.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

FIG. 1 is a schematic representation of a container of this invention depicting interrogation by laser light.

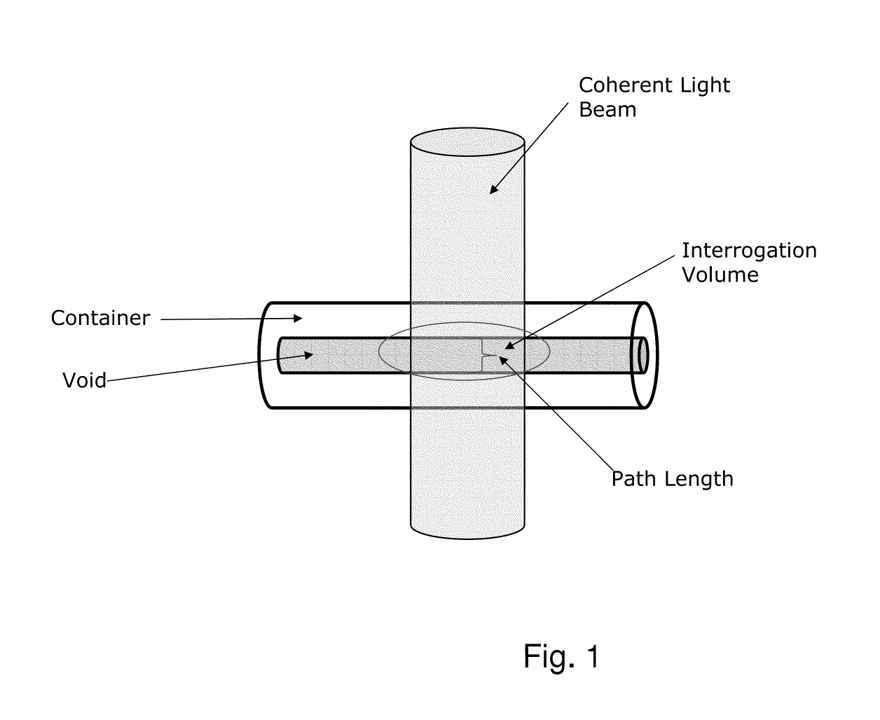

FIG. 2 depicts a flow diagram of a BSI system.

FIG. 3 depicts an example of an algorithm.

FIG. 4 depicts the Gaussian Fit Algorithm. The array of numbers describing the fringe pattern 401 and an array of numbers describing a reference fringe pattern 402 are used in a cross correlation 403. A Gaussian fit 404 of the highest peak of the cross correlation is calculated. The center of the Gaussian fit is calculated and then output 405.

FIG. 5 depicts the Gaussian fit with a Hamming window. Both the array of numbers describing the fringe pattern 501 and an array of numbers describing a reference fringe pattern 502 have a hamming window applied to the fringe pattern 503, then a cross correlation is performed 504. The Gaussian fit of the highest peak is calculated 505 and the center of the Gaussian fit is calculated and output 506.

FIG. 6 depicts the Sinusoidal Data Correction. After the algorithm 601 the data is split 602 to an output 603 and written to file 604. Once all the data is collected, the maximum and minimum values are found 605. Each value 606 is divided by (max−min)/2 then the new maximum is located 607. The (1−max) is added to each array value 608 (center around 0). The arcsine of each array value is taken 609. Using user selected regions 610, switch between Point B−Point A+previously calculated value and Point A−Point B+previously calculated value 611. Multiply each array value 612 by the same value that was used to divide in 606. Then write the data to file 613.

FIG. 7 depicts an exemplary full BSI device configured for analyzing a blood sample. The clamp 1301 holds the laser 1302 in place. The translation 1303 moves the laser 1302 to the left and right to allow alignment. The beam 1306 hits the tube 1308 and creates a fringe pattern 1305. A mirror 1307 is used to direct the fringe pattern 1305 onto camera 1304. The translation 1309 allows for the alignment of the camera 1304. The tube 1308 sits in a holder 1311 that is temperature controlled by a thermal electric cooler 1312 and a heat sink 1313 is used to dissipate the temperature difference. The angle adjustment 1310 is used to align the tube 1308.

FIG. 8 shows a BSI device for continuous flow-through of sample. The device comprises a syringe pump 704 and injection valve 705.

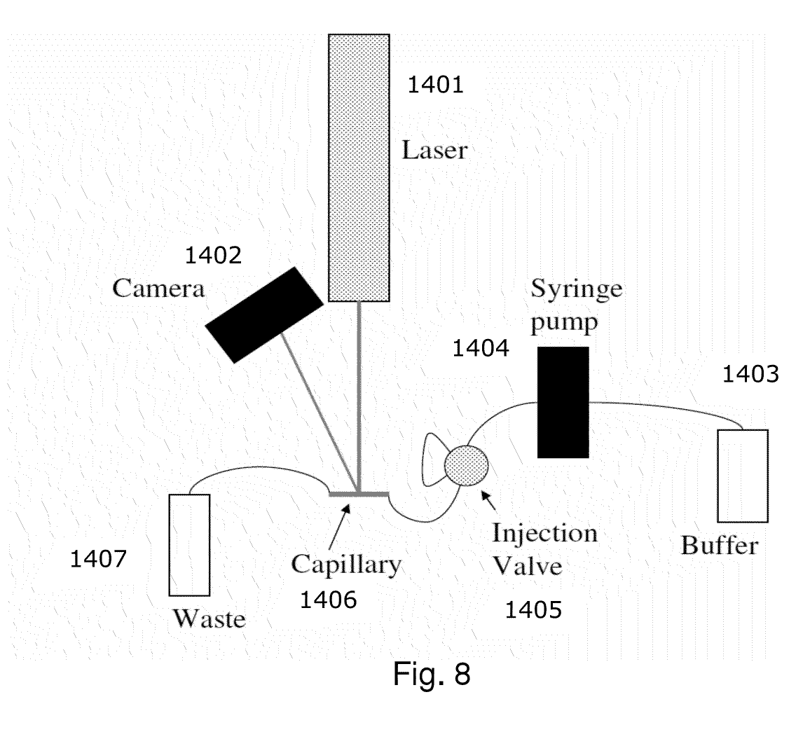

FIG. 9 shows the structure of some fluorinated surfactants.

FIG. 10 shows an example of a nanodisc.

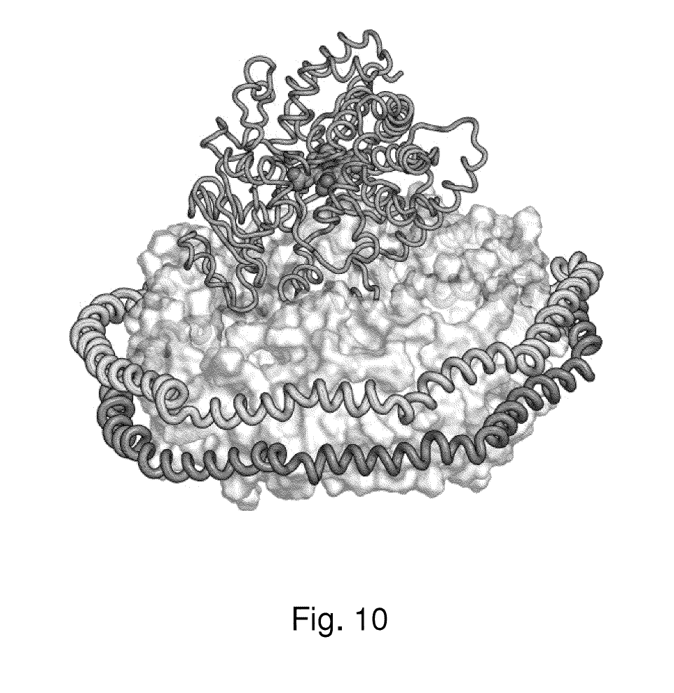

FIG. 11 shows an example of a lipoparticle.

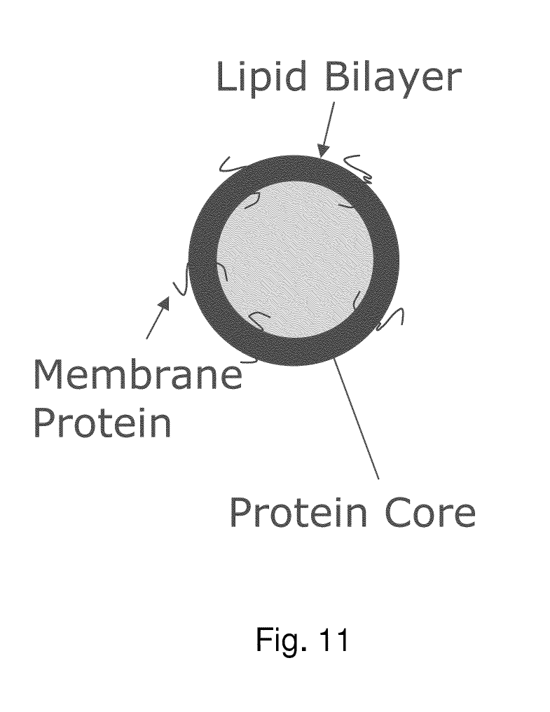

### DETAILED DESCRIPTION OF SPECIFIC EMBODIMENTS

### 1. Introduction

Back-scattering interferometry (“BSI”) is a sensitive method for detecting interactions between molecules. BSI detects molecular interactions as a function of changes in the refractive index of a solution that results from the interaction.

In back-scattering interferometry, coherent light is directed through a fluid to be analyzed that is contained in a void of a container comprised of a light transmissive material. The light typically passes in sequence through a first wall of the substrate, through the fluid and through a second wall of the material. In doing so, refracted and reflected light generates a fringe pattern, the position of which is a function of the refractive index of the fluid. Changes in the refractive index are determined by interrogating the solution with coherent light, for example laser light, to generate a backscatter fringe pattern, and detecting changes in the position of the fringe pattern.

BSI assays can be performed in homogenous and heterogeneous formats. Homogenous assays are performed in free solution. That is, neither analyte is tethered to the wall of the assay chamber. In one version, a homogenous assay is an endpoint assay, in which the analytes are mixed and allowed to equilibrate before introduction into the assay chamber. In another version a homogenous assay is a kinetic assay, in which the analytes are introduced into the assay chamber and allowed to equilibrate while changes in position of the backscatter pattern are measured.

In a heterogeneous assay one of the analytes is immobilized on an internal surface of the assay chamber. This invention contemplates assays in which (1) the member of the binding pair immobilized on the internal surface of the assay chamber is not associated with a nanoparticle and the member of the binding pair in solution is associated with a nanoparticle; (2) the member of the binding pair immobilized on the internal surface of the assay chamber is associated with a nanoparticle and the member of the binding pair in solution is not associated with a nanoparticle; and (3) the member of the binding pair immobilized on the internal surface of the assay chamber is associated with a nanoparticle and the member of the binding pair in solution also is associated with a nanoparticle. Heterogeneous assays also can be performed in endpoint and kinetic versions. In an endpoint assay a test solution is introduced into the assay chamber and allowed to equilibrate before measurements are taken. In a kinetic assay a stream of fluid comprising a bolus of a test solution can be passed through the assay compartment while measurements are taken on the refractive index over time.

### 2. Detection of Molecular Interactions Using the Nanoparticles

It has been found that the sensitivity of detection of interaction between molecules by BSI can be enhanced when one of the molecules is associated with a nanoparticle.

### 2.1 Size and Shape

Nanoparticles may take any appropriate shape, including for example, spheroid, oblong or flattened (e.g., discoid). In its longest dimension a nanoparticle typically will have a length between about 1 nm and 1000 nm (1 micron). In practice, the nanoparticle has a longest dimension that is about one-half to about one-tenth of the wavelength of light used to perform the interferometry. Lasers used for interferometry typically emit light in the visible and near IR range, that is, between about 350 nm and about 1000 nm. For example, a HeNe laser can produce light having a wavelength of 632.8 nm. Accordingly, nanoparticles used in this invention typically will have a longest dimension between 60 nm and 300 nm.

### 2.2 Composition

Any nanoparticles that can be bound with a molecule of interest can be used in this invention. For example, the nanoparticles can comprise a metal, a ceramic, a polymer or a macro-molecular structure. In certain embodiments the nanoparticle does not comprise a lipid, e.g., the nanoparticle does not comprise a liposome such as a small unilamellar vesicle, a large unilamellar vesicle or a multilamellar vesicle. In certain embodiments, the nanoparticle does not comprise a lipoparticle.

Depending on the nature of the nanoparticle and molecule, the molecule can be associated with the nanoparticle in a number of different ways. For example, the molecule can be covalently bound to a molecule of the nanoparticle. Also, the molecule can be non-covalently bound to the nanoparticle, e.g., by an affinity interaction. Affinity interactions include non-specific interactions, such as ionic attraction, metal chelation, hydrophobic interaction and hydrophilic interaction. They also include biospecific interactions, for example, binding between an antibody and antigen or between nucleic acids. In those instances in which the nanoparticle comprises a lipid, e.g., a lipid bilayer, the binding partner can be embedded in the lipid, for example, as the transmembrane portion of a membrane protein is embedded within a lipid membrane.

### 2.2.1 Metals

Metals useful as nanoparticles include, for example, rare earth metals. They may comprise gold, silver, titania, tin dioxide, yttria, alumina, and other binary metal oxides (such as ZnO), perovskites and other piezoelectric metal oxides (such as BaTiO₃) and ZnS. Gold nanoparticles are described, for example, in U.S. Pat. No. 6,495,324 (Mirkin et al., Dec. 17, 2002). They can be commercially obtained, for example, from Melorium Technologies (Rochester, N.Y.). The surfaces of metal particles can have or can be made to have reactive functionalities through which a molecule can be bound. For example, metals can have oxide surfaces. These oxides can be bound with bifunctional molecules, such as alkyloxy silanes. Reactive groups on one end of these silanes bind with oxides on the particles. Reactive groups such as amino or vinyl groups on the other end can react with the molecule of interest to tether the molecule to the particle.

### 2.2.2 Ceramics

Ceramics useful in nanoparticles include, for example, silica, e.g., quartz or glass. Silicas typically have surface oxides that can be bound using well known chemistries, such as the silane chemistries described above. See, e.g., U.S. patent publication 2010-0227315 (Poetter et al., Sep. 9, 2010).

### 2.2.3 Polymers

Polymers useful in nanoparticles include, plastics such as latex. Methods of binding proteins to latex particles are well known in the art. U.S. Pat. No. 4,837,168 (De Jaeger et al., Jun. 6, 1989) describes contacting the particles in an aqueous medium of appropriate pH wherein the desired proteins are dissolved. After a suitable period of time, the excess of protein is removed by repeated centrifugation and washing of the sediment with fresh buffer. After completion of the washing procedure, the latex particles are re-suspended in an aqueous medium which preferably contains an inert protein, e.g. bovine serum albumin, in order to protect the particles from non-selective interactions with non-specific proteins of the test samples. If desired, the proteins can also be bound covalently to the latex particles following the procedure described in U.S. Pat. No. 3,857,931 using a water soluble carbodiimide coupling agent. See also U.S. publication 2010/0227315 (Poetter et al., Sep. 9, 2010).

### 2.2.4 Macromolecular Structures

Macromolecular structures useful in nanoparticles include, for example, lipid-containing vesicles, lipoparticles, amphipols, fluorinated surfactants and nanodiscs. Lipid-containing nanoparticles are particularly useful for studying membrane proteins, as the membrane proteins can be associated with the lipid portion of nanoparticle so as to present the membrane protein as a binding partner to an analyte.

### 2.2.4.1 Liposomes

Liposomes comprise a lipid bilayer. Examples of liposomes are small unilamellar vesicles (SUVs), which have dimensions between about several tens of nanometers, large unilamellar vesicles (LUVs), which are have dimensions as large as about several hundreds of nanometers, and multilamellar liposome vesicle (MLVs). Liposomes can be created by sonicating phospholipids in water. Low shear rates create multilamellar liposomes, which have many layers. High-shear sonication tends to form smaller unilamellar liposomes.

Membrane proteins to be tested can be incorporated into liposomes by incubating liposomes with the proteins of interest. Several methods are known for incorporating proteins into liposomes. One frequently used method involves the use of detergents. In such a method, the proteins and phospholipids are co-solubilized in a detergent to form micelles. The detergent is then removed, resulting in the spontaneous formation of bilayer vesicles with the protein incorporated therein. Detergent that remains in the liposome can be removed by methods such as dialysis, gel exclusion chromatography or adsorption on hydrophobic resins.

Another method involves providing the membrane protein in a solution containing preformed liposomes formed by combining a mixture of phospholipids with a solution of at least one type of unsaturated fatty acid; and incubating the mixture. See, e.g., U.S. Publication 2002-0012699 (Singh et al. Jan. 31, 2002).

Another method involves the use of an organic solvent. Another method uses mechanical means, such as sonication or use of a French press, to produce large and small unilamellar vesicles from MLVs by swelling of the dry phospholipid films in excess buffer. Another method involves the direct incorporation of proteins into preformed small unilamellar liposomes.

### 2.2.4.2 Lipoparticles

The nanoparticle can include a lipoparticle. Lipoparticles are described, e.g., in U.S. patent publication 2007-0225227 (Doranz, Sep. 27, 2007). As described there, lipoparticles are small particles of about ten nanometers to about one micrometer, comprising an external lipid bilayer, a viral core protein, and at least one additional polypeptide that further comprises an ion channel polypeptide. Lipoparticles include enveloped virus-like particles. In some preferred embodiments, the lipoparticles are enveloped virus-like particles which comprise an enveloped viral core protein, a lipid bilayer, and an ion channel polypeptide. The lipoparticle may be about 10 nm to about 500 nm or about 100 nm to about 800 nm. The lipoparticle does not encompass cell membrane vesicles, which are typically produced using empirical methods and which are usually heterogeneous in size. The lipoparticle also does not encompass liposomes, which typically lack core proteins that induce their formation. In some embodiments, the lipoparticle is dense, spherical, and/or homogeneous in size. Lipoparticles are available from Integral Molecular (Philadelphia, Pa.).

### 2.2.4.3 Amphipols

Amphipols are amphipathic polymers that adsorb onto the hydrophobic transmembrane surface of membrane proteins. They are described in, for example, U.S. patent publication 2009-0275066 (Popot et al., Nov. 5, 2009) and Popot, Annu. Rev. Biochem. (2010) 79:737-775. Membrane proteins can be introduced into amphipols, nanodiscs and fluorinated surfactants by solubilizing the protein with a nondenaturing detergent that contains scaffolding proteins and lipids. The systems self-assemble when the detergent is removed.

### 2.2.4.4 Nanodiscs

Nanodiscs (NDs) are small patches of lipid bilayer whose rim is stabilized by amphipathic proteins. Certain Membrane Scaffold Proteins (MSPs) are discoidal in shape and are referred to as nanodiscs. Nanodiscs have the bilayer structure of normal membranes but are soluble. MSPs are artificial proteins which are self-assembled with phospholipids and phospholipid mixtures into nanometer size membrane bilayers. They are described in, for example, U.S. Pat. No. 7,662,410 (Sligar, Feb. 16, 2010) and Popot, Annu. Rev. Biochem. (2010) 79:737-775.

The molecule can be bound to the surface of the nanoparticle. Alternatively, when the nanoparticle is, for example, a lipid-based composition, the molecule can be bound within the nanoparticle.

### 2.2.4.5 Fluorinated Surfactants

Fluorinated surfactants resemble detergents but interfere less than detergents do with stabilizing protein/protein and protein/lipid interactions. They are described in, for example, Popot, Annu. Rev. Biochem. (2010) 79:737-775. The chemical structure of fluorinated surfactants resembles those of classical detergents, but their hydrophobic tails contains fluorine atoms.

### 3. Back-Scattering Interferometry

A back-scattering interferometer typically comprises an optical assembly and electronics to analyze an optical signal. The optical assembly can be mounted on an optical bench. Back-scattering interferometers are well known in the art. Back-scattering interferometers and their use are described, for example, in U.S. Pat. Nos. 5,325,170; 6,381,925; 6,381,025; 6,809,828 and 7,130,060; International applications WO 2004/023115, WO 2006/047408 and WO 2009/039466; and U.S. patent publications U.S. 2006/0012800, U.S. 2009/0185190, 2010/0099203 (Chang et al.), 2010/0184056 (Weinberger et al.) and 2010/0188665 (Dotson et al.).

The optical assembly comprises the following elements: First, a fluidic container has a compartment for holding a sample. A portion of the container in which the sample is contained functions as an interrogated volume, sensing area or detection zone. Second, the optical assembly comprises a coherent light source positioned to direct a beam toward the sensing area, wherein the path of the beam defines an optical train and generates a back-scattered light pattern, also called an interference fringe pattern. Third, the optical assembly comprises a photo-detector configured to detect the back-scattering light pattern. Typically, the instrument also will comprise a computer that converts the fringe pattern into a measure or indicator of refractive index. Optionally, the instrument comprises a temperature regulator that can maintain a stable temperature at least within the fluid during periods of measurement.

Several factors influence the generation of an interference pattern: Reflection, refraction and retardation (of the light beam). The coherent light beam should be large enough so that it passes across a non-flat surface from the container into the liquid. Accordingly, the compartment should comprise a curve or an edge (e.g., a corner) through which the light passes in order to generate a useful interference pattern.

### 3.1 The Container

The container used in this invention is adapted for use in back-scattering interferometry. The container is adapted to generate a back-scatter fringe pattern when filled with liquid and interrogated with a coherent light source, such as a laser beam. Factors that influence the ability to create such a pattern include the relative refractive indices of the substrate that forms the container and the liquid within, as well as the shape of the compartment in which the liquid is contained and the light source strikes.

The container can take the shape of a chip (e.g., a microchip). As in known in the art, chips can accommodate a plurality of channels or other features due to having one very thin dimension compared with their other dimensions. Including a plurality of channels allows one to perform matched experiments, to use one channel as a control against which to compare a test sample, and to perform multiple experiments in one chip. The container also can take the shape of a tube, such as a microcapillary tube. See, e.g., U.S. patent application US2010-0184056 (Weinberger et al., Jul. 22, 2010).

The volume of liquid through which the coherent light beam passes is referred to as the “interrogated volume”. The coherent light beam, in this case, is considered to be that portion of the beam for which the intensity is equal to its 1/e² value. Thus, the interrogated volume represents the intersection of the coherent light beam and the liquid. Typically, the light beam is sufficiently wide that it traverses a cross-section of the volume.

The fluidic container and the shape of the space through which the coherent light passes can take any shape desired. In certain embodiments, the compartment has the shape of a cylinder, a hemi-cylinder, an oblong, a rectangle or a triangle. In certain embodiments, the fluidic container has the shape of a tube, e.g., a cylinder. For example, the container can take the shape of a capillary tube.

### 3.1.1 Container Material

The container should be made of a material that has a different (e.g., higher) refractive index than the sample inside. The container can be formed of any suitable optically transmissive material, such as glass, quartz, borosilicate, silica (e.g., fused silica) or a polymeric material, e.g., a plastic such polystyrene, polysulfone, polyetherimide, polyethersulfone, polysiloxane, polyester, polycarbonate, polyether, polyacrylate, polymethacrylate, cellulose, nitrocellulose, a perfluorinated polymer, polyurethane, polyethylene, polyamide, polyolefin, polypropylene or nylon.

### 3.1.2 Compartment Shape and Size

The container will have an internal compartment that can hold the sample. Typically, the compartment will take the shape of a bore. The bore may have a curved cross section that is, for example, circular, substantially circular, hemi-circular, rectangular or elliptical. Back-scatter fringe patterns are easily produced when the substrate includes a compartment having curved or angular walls through which the light passes to reach the sample. In certain embodiments, the compartment takes a long, thin shape, such as a channel, column, cylinder or tube.

The container also is adapted to receive a liquid sample. In certain embodiments, the container is adapted to function as the collection unit of the sample from its primary source, e.g., a subject organism. For example, the container can comprise a channel or tube that opens at two ends of the container. For example, the container can be a capillary tube or a hematocrit tube, or a chip comprising a channel that opens at different sides of the chip.

The container can take the shape of a capillary tube or micro-hematocrit tube. The tube can be, for example, approximately 75 mm long, with fire-polished ends that can easily be sealed if desired. Tube can be coded with a red band to designate heparin coating. It can contain at least 2 U.S.P. units of cation-free ammonium heparin. It can have an internal diameter of 1.1 mm to 1.2 mm with a wall of 0.2 mm±0.02. The volume of the compartment can be between 20 microliters and 1000 microliters (10 milliliters), between 20 microliters and 1 milliliter, between 50 microliters and 1 milliliter or between 50 microliters and 250 microliters. Furthermore the tube can have dimensions as follows: Outside diameter 0.75 to 2.0 mm, inside diameter from greater than 0.150 mm or greater than 0.250 mm to 1.5 mm.

In other embodiments the channel has a diameter greater than any of: 1.0×10⁴ μm, 1×10³ μm, or 1.5×10² μm. In other embodiments the channel has a diameter no greater than 500 μm.

Moreover, the surfaces of the sample container could be coated with a material to minimize unwanted interactions with the walls of the container. Such surfaces would include polymeric coatings, such as dextran, Teflon, polyethylene glycol, etc. Furthermore, the surfaces of the container could be coated with biospecific reagents for selective capture of target analytes or selective enzymatic modification of target analytes as described above.

### 3.2 Container Mounting/Temperature Regulation

The device of this invention typically comprises a mounting adapted to receive the container and position it for interrogation by the coherent light source. The mounting can be removable from the frame of the device. The mounting can be attached to an optical bench that comprises other components of the optical system. The mounting can comprise a fastener to fasten the container to the mounting. If the container is a tube, the mounting can comprise, for example, a clip or set of clips, a surface with an indentation adapted to receive the tube, in which it can rest, an adhesive material, or a holder in which the container is inserted and held, e.g., a cylinder in which a tube is slid within and retained, a flat mounting stage on which a chip is locked into position. In certain embodiments the mount is in thermal contact with a temperature control assembly such as a Peltier device to insure homogeneous control of temperature as required to perform high sensitivity BSI measurements (+/−1-5 millidegree C.). See, for example, U.S. patent publication 2009-0185190 (Weinberger et al., Jul. 23, 2009).

A container of the invention can be adapted and configured to fit snugly within a holder. The container can be held in place by a positioner, such as a metal plate with tightening screws. The container can be manually inserted into the holder or cartridge. In an embodiment, the container is disposable while the holder can be used for numerous different chips with a device of the invention. A holder retention mechanism can be used to firmly hold the chip in the holder along the axis of the mechanism. The container and/or the thermal subsystem can be affixed to a translation stage that allows adjustment of the chip relative to the laser beam. For example, the container can be tilted slightly (for example, approximately 7°) so that the back-scattered light from the sensing area of the container can be directed onto the photo-detector.

In experiments that involve comparing the interference pattern between two samples (e.g., a test and control sample), the samples can be measured simultaneously or in sequence. In simultaneous measurements the two samples can be loaded into the interferometer and a beam splitter can split the laser beam and direct it to each of the two samples. Alternatively, the beam can be made wide enough so that a single beam covers both fluid compartments. In one embodiment, the first and second samples are comprised in different containers, e.g., tubes, and one tube is tilted or rotated, e.g., 3° to 7° with respect to the other tube. This results in the interference signal from each container being directed to different parts of the detector so that they are distinguishable.

In another embodiment, the first and second samples are located within a single tube, where the first sample represents a region of the sample container that contains a selectively deposited binding molecule for extraction and subsequent analysis of a target of interest, and where the second or reference sample represents a region of the sample container that is free of binding molecule, or moreover is coated with a specific passivating agent to minimizing unwanted non-specific binding of the target of interest.

Sample can be introduced into the container by any method known. For example, the sample can be introduced manually using a syringe, e.g., manual pipetter. Also, sample can be introduced into the container using a fluidics robot, such as any commercially available robot, e.g., from Beckman or Tecan.

### 3.3 Coherent Light Source

Examples of coherent light sources for use with the invention include, but are not limited to, a laser, for example a He/Ne laser, a VCSEL laser, an LED laser and a diode laser. The coherent light may be coupled to the site of measurement by known wave-guiding or diffractive optical techniques or may be conventionally directed to the measurement site by free space transmission. The coherent light is preferably a low power (for example, 3-15 mW) laser (for example, a He/Ne laser). The laser can emit light in the visible or near infrared range. For example, the laser can emit light having a wavelength of about any of 543 nm, 632.8 nm, 1.15 μm, 1.52 μm, or 3.39 μm.

As with any interferometric technique for chemical analysis, the devices and methods of the invention benefit from many of advantages lasers provide, including high spatial coherence, monochromaticity, and high photon flux. The beam can be directed directly to a sensing area on the fluidic chamber or to a minor that is angled with respect to the plane of propagation of the laser beam, wherein the mirror can redirect the light onto the sensing area. In another embodiment, the coherent light is preferably generated by a solid state laser source such as a light emitting diode or vertical cavity surface emitting laser (VCSEL), for which requisite beam characteristics of mono-chromaticity and beam coherence is achieved. In an embodiment, the coherent light source generates an easy to align collimated laser beam that is incident on a sensing area of the container for generating the backscattered light.

A coherent light source can have a cross-sectional area of at least 0.2 mm². The cross-section can take the shape of a circle, an ellipse or other oblong configurations.

### 3.4 Detector

A photo-detector can be configured and incorporated into a device of the invention to detect a fringe pattern produced by back-scattered light from a sensing area on a container. The pattern is based on the contents and/or composition of the sample. In an embodiment, qualitative and quantitative measurements are performed by forming molecular complexes, such as antibody-antigen or drug target-drug candidate. In an embodiment, the photo-detector detects a qualitative or quantitative value of an analyte in a liquid sample, for example, the amount of a specific antigen in a blood sample or host antibody titer towards a given antigen.

The photo-detector can be one of any number of image sensing devices, including a bi-cell position sensor, a linear or two-dimensional array CCD or CMOS camera and laser beam analyzer assembly, a slit-photo-detector assembly, an avalanche photodiode, or any other suitable photo-detection device. The back-scattered light comprises interference fringe patterns that result from the reflective, refractive, and retardative interaction of the incident laser beam with the walls of the sensing area and the sample. These fringe patterns include a plurality of light bands whose positions shift as the refractive index of the sample is varied, for example, through compositional changes. For example, a sample in which two components bind to each other can have a different refractive index than a sample in which the two components do not bind. In an embodiment, the photo-detector detects the back-scattered light and converts it into one or more intensity signals that vary as the positions of the light bands in the fringe patterns shift. For fringe profiling, the photo-detector can be mounted above the chip at an approximately 45° angle thereto. Fringe profiling can also be accomplished by detecting the direct back-scatter. In an embodiment, the fringes can be profiled in direct back-scatter configuration and direct them onto the camera which is at 90° from the beam. In this way, the packaged device can remain small while maximizing the resolution for measuring a positional shift, for example, the effect of angular displacement.

The optical detector can be placed at a distance that optimizes the number of interference fringes detected and their resolution. For example, typically, the detector should receive signal from at least one-fringe-width to detect movement of the fringe. However, receiving signal from at least two fringe-widths can be useful. Resolution can be a function of density of pixels in the CMOS or CCD camera. So, for example, using a CCD detector with a pixel density of 1316 pixels per inch, the detector can usefully be placed about 100 mm to 600 mm from the chip surface, e.g., about 270 mm.

### 3.5 Detection

BSI allows detection of an analyte in a solution by detecting interaction between the analyte and a binding partner. Detecting an analyte includes detecting its presence or its absence in the solution, as well as quantifying the amount of the analyte in the solution. Because BSI measurements are a function of refractive index of the interrogated solution, detection of analytes can be performed without detection of a signal produced by a label, e.g., can be performed label-free. That is, BSI detects alterations in the refractive index of a solution due to molecular interaction between analytes. Therefore, analytes need not carry, for example, a fluorescent or enzymatic label. Attachment of a label to an analyte may enhance changes in refractive index during interaction. The photo-detector can detect the back-scattered light fringe pattern and, in combination with computer algorithms, convert it into signals that can be used to determine a parameter of refractive index (RI), or an RI related characteristic property, of the sample. For example, the RI of a sample with a certain concentration of analyte in the sample can be slightly different than the RI of a sample where the analyte is present in the sample in a different concentration. A signal analyzer, such as a computer or an electrical circuit, can be employed to analyze the photo-detector signals and determine the characteristic property of the sample. Positional shifts in the light bands relative to a baseline or a reference value can then be detected by a photo-detector and computed using a processor, such as a PC. The device can provide a signal (for example, positional shifts in the light bands) that is proportional to abundance of the analyte. Preferably, the signal analyzer includes the programming or circuitry necessary to determine from the positional shift of the formed fringes, the RI or other characteristic properties of the sample to be determined, such as temperature or flow rate, for example. The parameter of refractive index can be, for example, the position of the bands on some scale of location. This position can be displayed as a number or as coordinate on a graph. For example, the coordinate on the Y axis can change over time on the X axis. The parameter can be quantitatively related to sample refractive index.

The signal analyzer can be a computer which, optionally, controls other aspects of the system. The computer functions to perform the calculations necessary to detect the fringe movement and output the data on the user interface. Moreover, the computer can function to store and retrieve method files which automate the performance of an assay or analysis, provides data analysis tools to determine binding profiles, qualitative measurements, and quantitative measurements, as well as providing a means to calibrate the system for total gain and output based upon a reference sample.

The photo-detector can be a camera, such as a CCD camera. The camera captures the image of the fringe pattern. A CCD camera can typically collect from one to 120 images per second. The image can be projected on a monitor for visual analysis. For example, the monitor can be calibrated and/or the operator can visually detect changes in the fringe pattern over time. Alternatively, the image can be subjected to a variety of mathematical algorithms to analyze the fringe pattern. Examples of algorithms used to analyze fringe pattern are Fourier transforms, Gaussian fit with or without hamming window and sinusoidal correction.

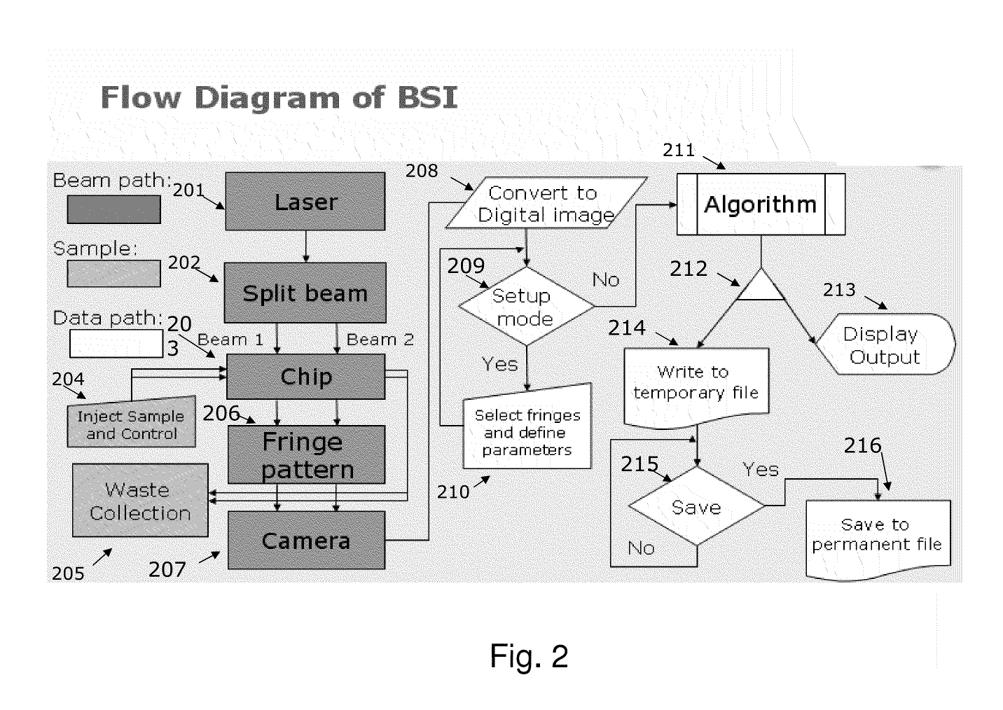

FIG. 2 depicts a flow diagram of a BSI system. A laser 201 produces a beam that passes through a beam splitter 202 to create two beams. A beam splitter is optional but useful for comparing first and second samples. These two beams impinge onto a chip 203. The two-channel chip allows for the injection of samples and controls 204. The liquid that is injected passes through the chip 203 and then can be collected as waste 205. The interaction of the beams and the channels creates fringe patterns 206. These two fringe patterns 206 are directed onto a camera 207. The data acquired from the camera 207 is converted into a digital image 208. Initially, the program is started in setup mode 209, which allows the user to select the fringes to be analyzed and define the parameters of the analysis 210. Once setup mode 209 is turned off, the digital image 208 is passed to an algorithm 211 that calculates shifts in the fringe pattern 206. This output is split 212 to a real time output display 213 and is also written to a temporary file 214. At any time the user can save the data 215, which then writes the data to a permanent file 216.

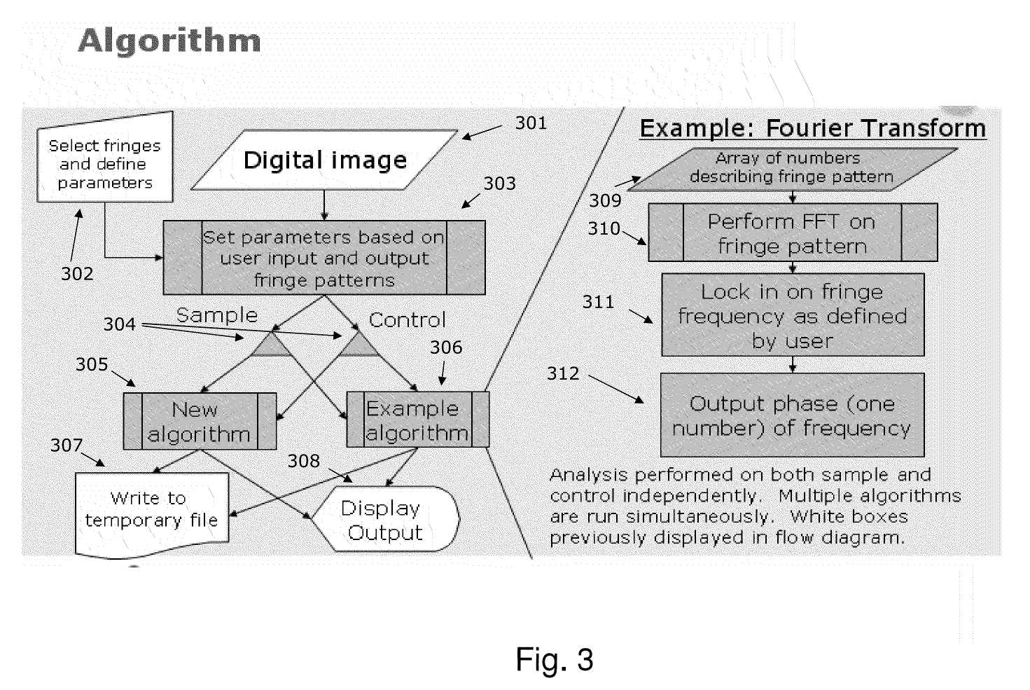

FIG. 3 depicts an example of how an algorithm can be utilized according to the methods and systems herein. Interferometry, e.g., back-scattering interferometry, produces an interferometric pattern referred to as a fringe pattern. The fringe pattern produced by a sample being analyzed is captured by a photo-detector, such as a CCD camera, at a plurality of different times. The digital image 301 and user input for fringes and parameters 302 are used to select the regions from the digital image 301. The camera allows for two regions to be selected (for example, sample and control for most applications). In this example, FIG. 3 demonstrates a method of verifying and comparing 304 a method and system provided herein (new algorithm 305) and an algorithm known in the art (example algorithm 306), such as the Fourier Transform technique. The program allows, for example, for multiple analyses to be performed simultaneously. The data from these algorithms can be written to a temporary file 307 and displayed 308 in real time or on demand from a user. As described herein Fourier Transform data analysis can be used to detect positional shifts of fringe patterns and is used in many other analysis techniques, such as FTIR. The digital image output 308 can be utilized by the algorithm as an array or matrix of numbers that describe the fringe pattern 309. A Fast Fourier Transform can also be utilized and performed as demonstrated in this example 310. As described herein, in contrast to the new algorithm 305, the Fast Fourier Transform algorithm 306 requires locking in on the spatial frequency 311 as defined by the user in 302. Also as described, this can limit the algorithm's ability to handle data with a dynamic range and can limit the analysis to pixel-level positional shifts. The output of the algorithm is the phase of the spatial frequency 312. The algorithm can be applied to both the sample and reference data simultaneously.

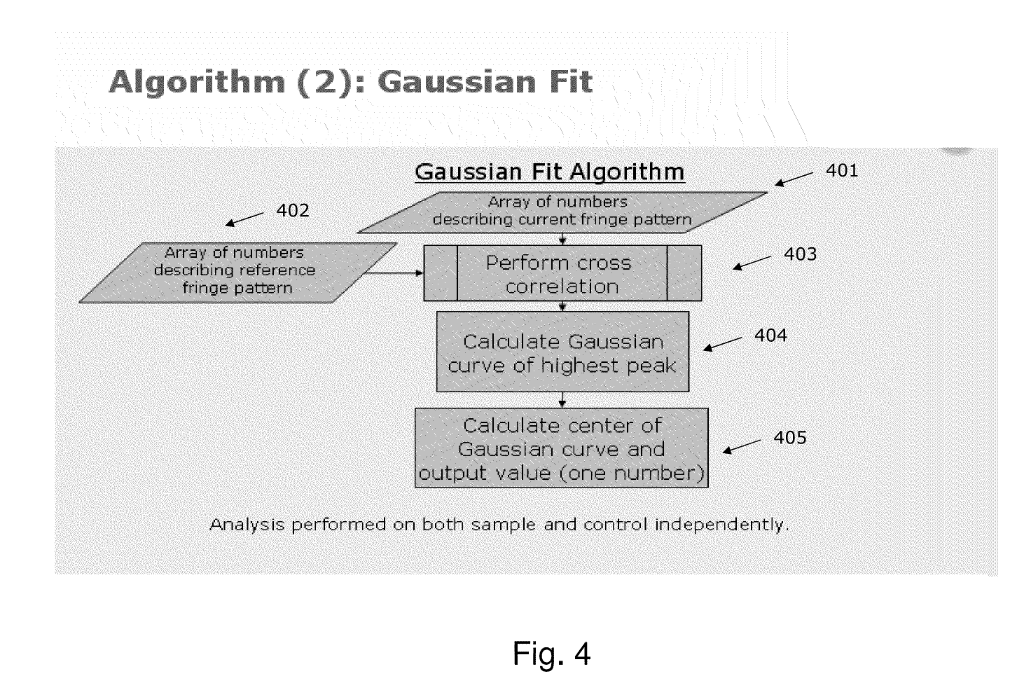

FIG. 4 shows a diagram of the digital image process 401 with the Fourier transform algorithm as an example. The Fourier transform transforms a digital image into a function that describes the image 409 and 410. Phase changes for the predominant spatial frequency 411 in the Fourier transform over time can indicate shifts in the fringe pattern 412.

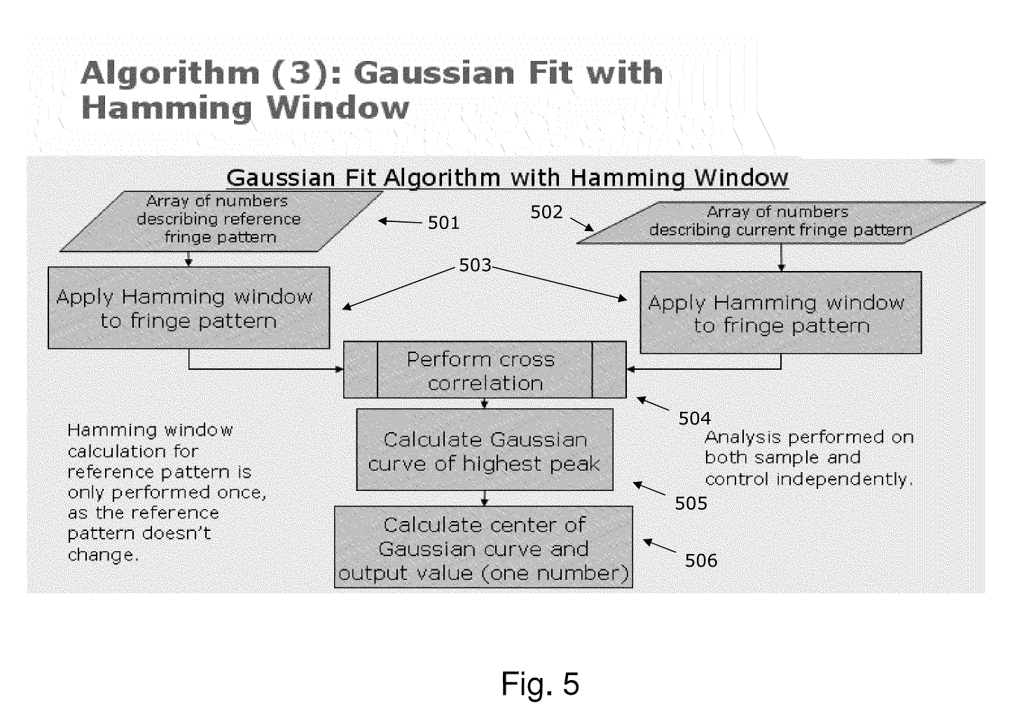

FIG. 5 shows the Gaussian fit analysis. A cross correlation 503 is performed on a reference fringe pattern 502 and a new pattern 501. A Gaussian fit is calculated 504 from the highest peak of the cross correlation. The calculated center of the Gaussian fit 505 is used to measure the pixel shift, which allows for sub-pixel shift detection. This method is described in more detail in U.S. publication 2010/0188665 (Jul. 29, 2010).

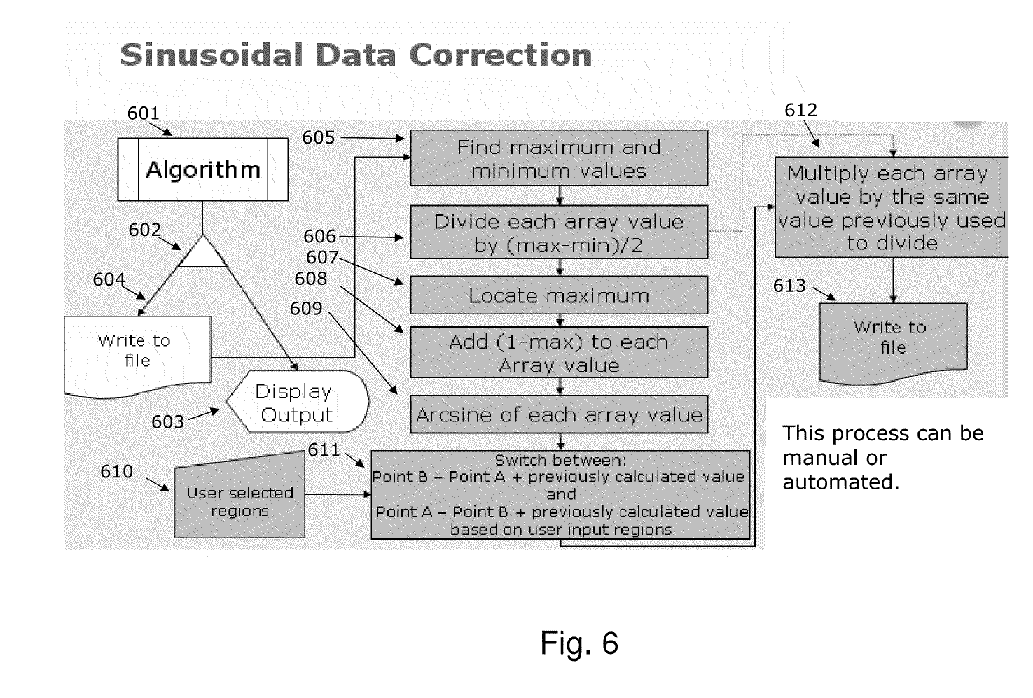

FIG. 6 shows the use of a hamming window, which is applied to the fringe pattern before the cross correlation is performed 603. Then a Gaussian fit 605 of the cross correlation 604 is used to determine the shift in the fringe pattern. The hamming window helps to minimize noise.

BSI can detect changes in refractive index in real time. Therefore, it is a useful tool for measuring binding assays in real time. Also, BSI can be used to compare two samples for differences in refractive index, thereby indicating differences between the contents of the two samples. This method is described in more detail in U.S. publication 2010/0184056 (Jul. 22, 2010).

Interferometric detection is amenable to high throughput assay methods, as the molecules, particles or cells do not require labeling with other reagents, such as fluorescent tags, thus requiring less processing of individual samples. The presence of the mass of the immobilized target or a signal due to a binding pair in solution, in embodiments where no binding moiety is immobilized, is detected directly as a function of interferometric fringe position and is robust under laser interrogation. The resulting signal is not susceptible to the photo-bleaching and loss of precision under long or repeated laser exposure of fluorescently labeled targets. Interferometric detection is a sensitive method of detection. Zeptomole levels of numbers of molecules can be detected and low to sub-picomolar (10⁻¹²) concentrations of target molecules can be detected.

3.6 Instrument with Continuous Injection

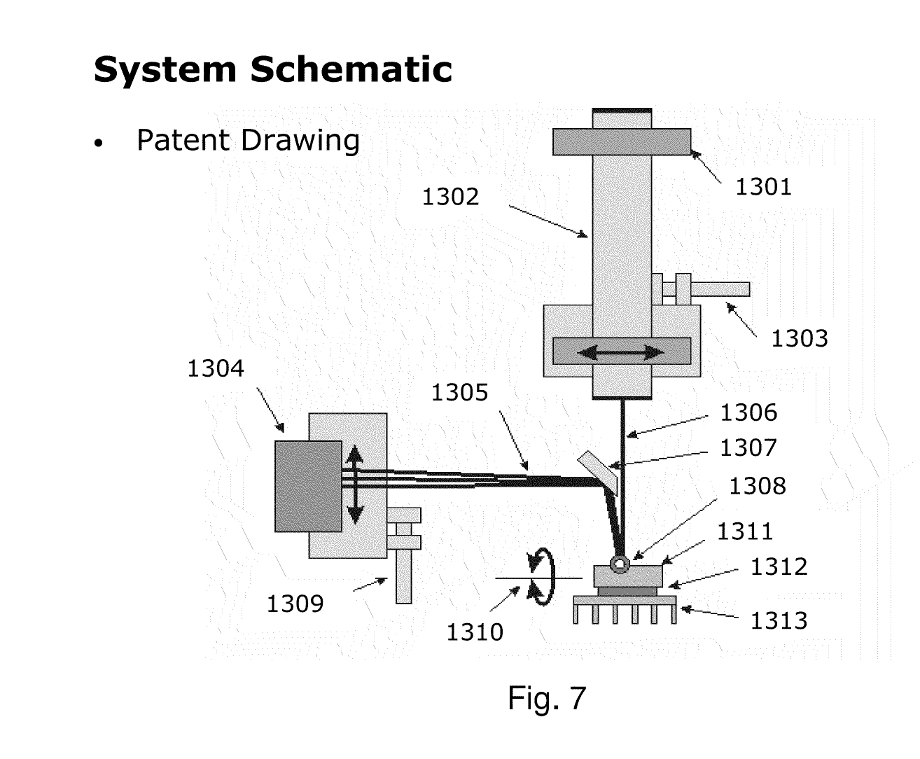

One version of the instrument allows for sample analysis in flowing streams. (See FIG. 7.) The basics of the instrumentation are the same; a coherent light source 701 is directed onto a fluidic channel 706, which produces a fringe pattern that is captured by a camera 702.

A syringe pump (Cavro) 704 is utilized with an injection valve to create a flowing system. The syringe pump pulls in a volume of liquid from a container 703 which is then dispensed at desired flow rates. These rates can range from 10 microliters per minute to 0.5 microliters per minute, e.g., approximately 2.5 μL/min. The fluid passes through an injection loop and then the detection zone of the instrument. This provides a continuous flow of running buffer in the system. The injection loop can have a volume of 20 μL that can be changed based on the size and length of tubing used. The injection valve 705 allows the injection of different samples without disrupting the flow of the system, as when in the load position the valve circumvents the loop allowing the running buffer to continuously flow. A sample is injected using a 250 μl analytical glass syringe into the loop. When the valve is switched to the inject position, the running buffer flows through the loop, pushing the injected sample into the detection zone. Thus the flow is never interrupted, aside from during the pump refill cycle.

The injected samples are pushed into the BSI instrument, which has a holder, which equilibrates the temperature of the fluid to a set point (typically 25° C.) by wrapping the capillary around a metal bobbin that is temperature controlled. The fluid is then pushed into the detection zone.

The detection zone is a small piece of capillary that the laser strikes. The small section of the capillary allows for surface chemistry to be performed on a large section and then cut into smaller sections for a heterogeneous experiment. After the fluid is analyzed, a waste tube is used to direct the sample into a waste container 707.

### 3.7 Creation of Lipid-Like Layer on Compartment Surface for Heterogeneous Assay

In certain embodiments, this invention involves creating a lipid-like layer on the internal surface of the compartment that is to be interrogated. Lipid-based nanoparticles can be attached to the compartment wall covalently or non-covalently. One method of non-covalent binding involves immobilizing a lipid-like layer to the internal surface of the channel and using this layer to bind the lipid-based nanoparticle being tested.

A lipid-like layer can be formed on a surface of a compartment wall by any method known to couple molecules to a surface. One method involves attaching bifunctional linkers to the surface and then attaching the molecule having a lipid-like portion to the free functional group of the bifunctional linker. Such methods are described, for example, in U.S. Pat. No. 7,045,171 (Bookbinder) and U.S. patent publication 2010-0291700, Nov. 18, 2010 (Weinberger et al.).

In order to create a surface in the fluidic channel that is lipid like, one can create a surface that comprises large linear or branched aliphatic chains. Using surface chemistry that is based on primary amine binding, it is possible to bind a hydrophobic molecule like hexadecylamine to the surface where a hydrophobic surface would be created. For example, 3-mercaptopropyltriethoxysilane and N-(γ-maleimidobutyryloxy)succinimide ester is used to create the initial surface layer on the fluidic channel, which then interacts with the primary amine of a long chain alkyl amine. A variety of chain lengths exists which can be bound to the channel surface and experimentation can be performed to optimize the chemistry for the membrane. Also these long chains are insoluble in water and must be dissolved in a solvent that is favorable to the previous surface chemistry (in ethanol for example). Once the long chain alkyl amine layer is created it is possible to bind the membrane to the surface of the channel.

In certain methods, surfaces are prepared for attachment with a lipid-like layer by modifying the surfaces with bifunctional coupling agents, that is, reagents bearing reactive groups at both termini. One end is used to attach to the surface. The other end is used to attach to a molecule having a lipid-like quality.

For some embodiments of the invention, the chemical moieties on the substrate surface which are amenable to chemical modification are hydroxyl groups. For example, glass substrates present a population of hydroxyl groups. The density of these hydroxyl groups depends on the handling and storing conditions to produce the glass substrate. A number of other substrates also exhibit hydroxyl groups as usefully modifiable chemical moieties on the surfaces of those substrates. Other chemically modifiable groups may include, but are not limited to sulfides, sulfhydryls, amino groups, boronates, carboxylates, and the like.

In plastic substrates, surfaces can be oxidized using corona or plasma discharge, creating a covalently attached oxidized layer with associated hydroxyl groups for subsequent coupling via bifunctional agents.

The substrate is cleaned in preparation to applying a layer to it. In some embodiments, the cleaning step comprises chemical treatment which will induce the formation of chemically modifiable groups on the substrate surface, for example, the introduction of oxide groups on a metal surface. Alternatively, corona or plasma discharge can be used.

The reagent bearing reactive groups at both termini is used to functionalize the chemically modifiable groups already present on the substrate surface, by reacting at one of the two termini with the chemically modifiable group on the substrate surface, and retaining the second reactive group for further reaction with a polymer or other species that will act to modulate the nonspecific binding and/or be capable of further modification to induce specific binding of the target molecule, particle, or cell. The reactive group still present at the second terminus is often more reactive than the chemically modifiable group on the original untreated surface and can therefore react with a wide variety of chemical species to introduce surface modification which will modulate nonspecific binding and/or be capable of inducing specific interactions of desired molecular species with the substrate.

Examples of the reagent bearing reactive groups at both termini to initially modify the substrate surface for use in the present invention include, but are not limited to, isocyanates (e.g., toluene diisocyanate), silanes, methacrylates, disulfides, disilazanes, sulfhydryls, acrylates, carboxylates, activated esters, other active leaving groups, isonitriles, phosphoamidites, nitrenes, epoxides, hydrosilyl, esters, arenes, azido, amine, nitrile, vinyl groups, alkylphosphonates, and other surface-coupling reactive species known to those skilled in the art of chemical coupling to surfaces. In some embodiments, the reagent bearing reactive groups at both termini bears at least one silane group, a group selected from a methacrylate group, a disulfide group, a disilazane group, a sulfhydryl group, a acrylate group, a carboxylate group, an activated ester group, an active leaving group, an isonitrile group, an isocyanate group, a phosphoramidite group, a nitrene group, an epoxide group, a hydrosilyl group, an ester group, an arene group, an azido group, an amino group, a nitrile group, a vinyl group and an alkylphosphonate group. The reactive groups at both termini may be the same or different.

In one embodiment, a surface having free hydroxyl groups is washed with 10% (w/w) potassium hydroxide in methanol. The surface is then bound with tri-alkoxy silane having an alkyl group and a reactive group at a second terminus. For example, the compound can be mercapto propyl triethoxy silane in toluene. In certain embodiments, the reactive group at the second terminus can be directly coupled to the molecule bearing the lipid-like moiety. Alternatively, the reactive group at the second terminus can be converted into another reactive group that will be coupled to the molecule. For example, the free thiol group described above can be reacted with a maleimide succinic esther to generate a thioesther group. For example, the reactant can be N-(γ-maleimidobutyryloxy)succinimide ester in ethanol. The reactive thioesther group can react with a molecule comprising a lipid-like moiety, e.g., a hydrophobic, moiety.

A molecule comprising a lipid-like moiety is then attached to the available reactive group of the bifunctional linker already attached to the surface to provide a hydrophobic surface that has affinity for lipid membranes. Typically these molecules comprise a reactive group, such as an amine, to bind with the available reactive group on the linker and a lipid-like moiety. In certain embodiments, the molecule comprises a hydrophilic linker that attaches the lipid-like moiety to the bifunctional linker. However, in other embodiments, the lipid-like molecule does not have a hydrophilic linking moiety.

The reactive moiety can be any moiety that reacts with the available functional group on the bifunctional linker to produce a covalent bond. In some embodiments the molecules having a lipid-like moiety are attached to the bifunctional linker through a thiocarbamate bond, a carbamate bond, a urethane bond (e.g., through reaction with an isocyanate), an amide bond, a guanidinium bond, an ether bond, a sulfide bond or a disulfide bond.

The lipid-like moiety typically has a high hydrophobic index. In one embodiment the membrane binding moiety or “hydrophobic tail” of the lipid-like molecule can be hydrophobic or amphiphilic with straight or branched chain alkyl, alkynyl, alkenyl, aryl, araalkyl, heteroalkyl, heteroalkynyl, heteroalkenyl, heteroaryl, or heteroaraalkyl. The lipid-like region that binds to the membrane can comprise a C₁₀ to C₂₅ straight or branched chain alkyl or heteroalkyl hydrophobic tail. For example, the lipid-like moiety comprises a C₁₀ to C₂₀ straight or branched chain alkyl fragment. For example the lipid like moiety could comprise a long chain (e.g., C₁₀ to C₂₅) alkyl such as a C₁₋₆ alkyl. They may comprise a primary amine group to react with the lipid like moiety. For example, the lipid-like molecule could be hexadecyl amine. Long aliphatic chains are insoluble in water and must be dissolved in a solvent that is favorable to the previous surface chemistry, for example, ethanol.

Other means of immobilizing lipoparticles include direct covalent coupling using carbonyl diimidizole (CDI) directly to carboxylic acid groups of the lipid fatty acids.

Other means of immobilizing lipoparticles includes direct covalent attachment via primary amine or primary alcohol groups found upon membrane integral proteins using NHS esther chemistry (amine) or epoxy chemistry (primary alcohols).

Other means of immobilizing lipoparticles could make use of immobilized antibodies directed against a membrane integral protein of the lipoparticles.

In other embodiments, the link can be a non-covalent link in which the groups have a tight binding affinity, such as a chelating group and metal ion.

In one embodiment, lipid membrane is immobilized to the compartment wall in a way that allows the lipid-based nanoparticle to bind to the surface of the channel without denaturation. A fluid comprising an analyte for testing with the lipid-based nanoparticle comprising the analyte of interest is flowed through the compartment. The binding of these substances to the membrane can then be monitored.

A channel comprising a lipid like layer as described above can be provided. Then, a nanoparticle preparation is contacted with the lipid like layer. Because the lipid like layer has affinity for the lipid-based nanoparticle, the membrane sticks to the layer. Once the channel is prepared, the preparation of experiments is set up in a heterogeneous fashion. A varied concentration of the substance that interacts with the membrane is introduced in increasing concentration. The rinsing buffer must be set up so that the membranes are in a favorable environment.

This fluidic channel setup would allow for either stop flow or flowing experimental configuration. In the stop flow experiment, the increasing concentration of samples would provide increasing signal strength until saturation is reached. The binding affinity can then be calculated based on a one site binding hyperbola. In the flowing system, monitoring of the Kobs (one phase exponential association) and Koff (one phase exponential decay) for each concentration would allow for Kd calculations.

In both the flowing and stop flow experiments, correct controls must be analyzed. In this case, the control can be a fluidic channel that has not been surface activated. Preferentially, a control membrane that has no reactivity for the substance being analyzed can be bound to the surface.

### 4. Detecting Molecules and Molecular Interaction

### 4.1 Assays

The methods of this invention are useful in detecting analytes in which the least concentrated member involved in the interaction has a concentration less than 5.0×10⁻⁷M, less than 1.0×10⁻⁷M, less than 5.0×10⁻⁸M, less than 1.0×10⁻⁸M, less than 5.0×10⁻⁹M, less than 1.0×10⁻⁹M, less than 1.0×10⁻¹⁰M, less than 5.0×10⁻¹⁰M, less than 5.0×10⁻¹¹M, less than 1.0×10⁻¹¹M, less than 5.0×10⁻¹²M, or less than 1.0×10⁻¹²M.

Interaction measurements can be performed with BSI by either real-time kinetics with on-chip mixing or off-line mixing with equilibrium end-point determination of K_{D}. The method can be used to determine equilibrium K_{D} and kinetic profiles of binding systems (e.g., an equilibrium constant, a dissociation constant, a dissociation rate, a dissociation rate constant, an association rate, an association rate constant or the quantity or concentration of analyte in a sample).

An analyte can be detected in a sample in a number of ways. First, the interference patterns of a sample and a matched control can be compared. For example, a control sample should contain the same reagents and be contained in a container of the same dimensions as the test sample, but exclude the analyte. In this case, an important element that contributes to differences in the interference patterns will be differences in interaction between the analyte and the reagents in the two samples. For example, in a binding assay, differences between the concentration of an analyte between the two samples will result in differences in amount of binding with a binding reagent, which, in turn, will result in differences in the interference pattern produced. This method can be performed in a two-channel system in which the instrument interrogates one channel containing the analyte and another channel containing the control, for example by splitting the laser beam used to interrogate the channels.

However, control and test samples may not be evenly matched. For example, a control plasma sample and a test plasma sample may have differences in various molecules that will result in differences in refractive index even if the concentrations of the analytes are the same. If analyte concentration differences contribute most to differences in refractive index, then this need not be an issue. However, these differences can be addressed in various ways. For example, a kit can provide reagents to construct a standard curve. Measuring results on the test sample against the standard curve provides an indication of the quantity of the analyte in the sample. Comparison of two samples, one with the reagents and one without, provides a measure of what contribution the presence of analytes makes to changes in refractive index. A test sample can be divided between two containers, one with reagents and one without, for this purpose. In this approach sample and reference measurements are performed on the sample matrix solution, variations in biological matrix, such as serological composition, ionic strength, and other bulk propertied can be compensated enhancing the signal to background.

A method for free-solution determination of molecular interactions can comprise the steps of: introducing a first sample comprising a first non-immobilized analyte into a compartment of a container of this invention; introducing a second sample comprising a second non-immobilized analyte to be analyzed into the compartment; allowing the first analyte to interact with the second analyte to form one or more interaction products; directing a coherent light beam onto the container such that the light beam passes, in sequence, through a first wall of the container, through the compartment containing the analytes and through a second wall of the container, thereby generating back-scattered light comprising an interference fringe pattern; and detecting a position of the interference fringe. Detecting changes in the position of the interference fringe pattern over time reflect changes in the refractive index of the fluid being interrogated which, in turn, indicate interaction events between analytes in the sample. The first and second analytes can be mixed and introduced into the compartment together. Alternatively, the analytes can be introduced from different volumes simultaneously, e.g., by combining two streams of liquid. Alternatively, they can be introduced in sequence.

Pre-mixing, end-point BSI determinations can facilitate accurate K_{D} determinations providing crucial biophysical information such as the quantification of the affinity of a binding pair. Sample preparation for the binding curve is straightforward. A titration series of the ligand or a control (a molecule that does not bind to the binding partner of the ligand) is prepared and a titration curve is created using BSI. Another titration series is prepared in which the ligand or control at successively increasing concentrations is combined with the receptor off-line at concentrations to produce pseudo first order binding conditions (receptor concentration held constant). This is usually achieved by having the receptor concentration held constant at 1-10% of the target K_{D} and titrant concentrations ranging from 1/10 to 5 times the target K_{D}. This process can be done using small volume pipettes and micro-centrifuge tubes. Once combined, the samples are allowed to equilibrate prior to introduction into the BSI instrument for creation of a titration curve. Subtracting the titration curves ligand or control with and without the receptor produces a binding isotherm showing changes in refractive index due to binding between the two analytes. A hyperbolic fit of this binding isotherm produces Bₘₐₓ, which in turn identifies the actual K_{D} at ½ Bₘₐₓ. Bₘₐₓ is the X-intercept of a Scatchard plot of binding data. It indicates the concentration which results in the saturation point for a binding system.

The concentration of analyte in a sample can be determined in the following way. A titration series is created using aliquots of a sample with similar characteristics to the test sample, spiked with the analyte at different concentrations. Using a binding partner for the analyte, a standard curve binding isotherm is created. The binding partner concentration is well above the K_{D} to maximize the linear detection range and lower limits of detection. Then, the binding partner is combined with a test sample and tested by BSI. The resulting signal is compared with the standard curve binding isotherm to indicate analyte concentration.

The system can be used to determine the on- and off-kinetics of binding with a flowing system. In the flowing system, one molecule can be attached to the surface with chemistry. A running buffer is then flowed over the activated surface. Once the signal is stable, a second molecule that binds to the first is flown through the system in increasing concentrations. When the sample interacts with the surface, there is an increase in signal until equilibrium is reached. When the running buffer is flowed back through, the bound molecules disassociate and the signal decreases and then equilibrates on the running buffer. For the reaction of the two molecules, an increase in signal is observed and then equilibrates. For this part of the curve, a ‘one phase exponential association’ equation is used [Y=Ymax*(1−exp (−K*X))] where K is the K-observed. For the dissociation of the two molecules, a decrease in signal is observed until equilibrium is reached. For this part of the curve, a ‘one phase exponential decay’ equation is used [Y=Span*exp (−K*X)+Plateau], where the K is the K off. The K-on value is calculated by subtracting the K-off from the K-observed then dividing the value by the concentration of the binding ligand {Kon=(Kobs−Koff)/[ligand]}. The K_{D} value is collected by dividing the K-off by the K-on [K_{D}=Koff/Kon]. These equations assume one to one binding and that the concentration of one of the molecules is unchanged during the reaction. This is accomplished by the use of flow as there is a constant amount of the same concentration of ligand being introduced into the channel.

BSI also is useful for drug screening. A test compound, such as a drug candidate is contacted with two members of a binding pair, at least one of which is associated with a nanoparticle. The test compound can be a small organic molecule, e.g., an organic molecule of a size comparable to those organic molecules generally used in pharmaceuticals.

BSI is used to determine whether the test compound has an effect, positive or negative, on the binding of the members of the binding pair. For example, two solutions can be run side-by-side, one in which the test compound is present with the binding partners, and one in which the binding partners are present without the test compound.

The first and second analytes can be unlabeled or one or more can be labeled. Such labeling can be convenient for preceding, subsequent, or simultaneous analysis by other analytical methods.

In addition to monitoring molecular interactions, back-scattering interferometry can be used to study single molecule or unimolecular properties. For example, the described BSI device can be used to quantify the amount of a molecule within a solution. In this case, a quantification calibration curve is constructed by measuring the refractive index signal for a dilution series of samples, with known concentrations of analyte. Under these conditions, the BSI signal is known to be proportional to analyte concentration, and as such, the resulting calibration curve can be applied to determine the quantity of the same analyte in an unknown solution of identical solvent composition.

BSI can also be used to study unimolecular response to thermal and solvatic affects, such as changes in chaotropic strength, ionic strength, or pH. It is recognized that the BSI signal for a given species is not only concentration dependent, but is also dependent upon the conformation and/or solvation state of that species within a given solvent system. As such, solvation conditions for a single molecule can be altered by changing solvent pH, ionic strength, as well as temperature. Under such conditions, many molecules undergo changes in their solvation state and/or conformational state, with a concomitant change in the measured BSI signal. The latter is particularly true for many biopolymers with secondary, tertiary and/or quaternary structure. A typical experiment is now described. A given protein is studied with respect to change in confirmation and/or solvation state as a function of pH. A pH series of the protein is created in which the total concentration of the protein is held constant, and only the pH of the solvent (buffer) is altered. The refractive index signal of each solution is measured and then compared to the reference pH sample. The change in BSI signal when compared to the reference is indicative of the change in the protein's confirmation and solvation state. The measurement can be simultaneously performed using a plurality of channels. It is recognized that similar experiments can be performed during which the chaotropic strength, ionic strength, or temperature of the buffer is altered to assess impact to the target protein.

Another unimolecular property that can be studied using BSI is compound solubility. As previously described, for a given compound and a given solvent condition, the measured BSI signal is proportional to compound concentration. Accordingly so, BSI can be used to determine the solubility of a given compound within a selected solvent. To do so, a dilution series of target compound is created within a given solvent. The BSI signal for each solution is determined. As the concentration of the target increases, so does the BSI signal in classical monotonic (linear) fashion. When the solubility limit of the compound is reached, there is an observed saturation of the BSI signal, which begins to roll off, and deviate from its linear relationship with solute concentration. The point of inflection for this relationship represents the solubility limit of the solute. This measurement can be simultaneously performed using a plurality of channels.

Yet another unimolecular property that can be studied using BSI is compound aggregation. The detection of compound aggregation is especially important in a number of research activities, such as drug screening and drug development, where it is critical to discover new drug candidates that interact with a high value target of interest in a well behaved manner. Compound aggregation is typically studied using a variety of light scattering techniques, which leverage the relationship between particle size and elastic scatter of light. Various static and dynamic light scattering techniques exist, based upon this approach as manifested in low angle light scattering and multi angle light scattering instruments. While widely employed, light scatter based molecular aggregation detectors fail to detect molecular aggregation for small molecular weight compounds such as those generally investigated for new drug targets which have a hydrodynamic radii less than 15 nm or less than 10 nm. While detection limits vary among different devices, it is generally accepted that the sensitivity of light scatter based detection significantly decreases for compounds with a molecular weight of less than 1 kDa. Consequently, BSI provides a new detection scheme that can monitor and detect the aggregation of low molecular weight compounds with small hydrodynamic radii, such as those which are typically investigated in drug discovery research.

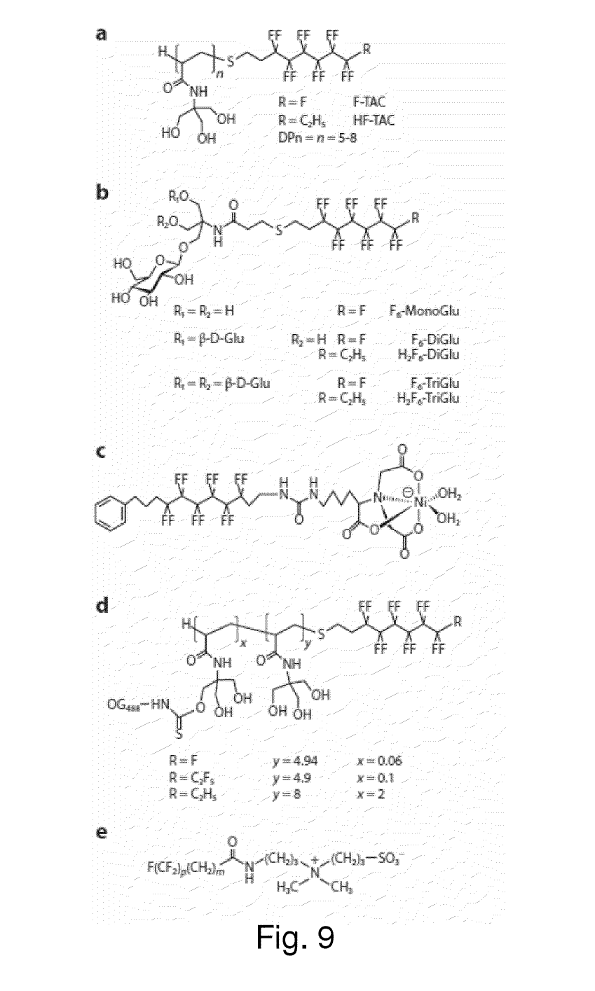

BSI can detect the aggregation of compounds, in a mass independent manner, and as such, represents a preferred method of investigating compound aggregation for drug discovery research. When molecules aggregate, they create a binding signal that can be detected by BSI. A typical BSI experiment to detect compound aggregation proceeds in a similar manner as the previously described solubility assessment protocol. As such, a dilution series of the compound of interest is prepared and measured using BSI. As the concentration of the compound increases, the determined change in refractive index (BSI signal) increases in classical linear fashion until molecular aggregation initiates (see FIG. 9). Upon aggregation, a binding signal is produced which causes deviation from the classical concentration dependent linear change in measured refractive index. Dependent upon a number of factors, which include changes in compound solvation state which effect hydrodynamic radii as well as dipole and multipole moments and/or dissolution, the aggregation binding signal can result in a positive (increasing refractive index) or negative (decreasing refractive index) deviation from linear behavior. Deviation from linearity continues until compound aggregation results in precipitation of the compound from its solvent system, at which point, increasing concentrations of compound do not affect the observed BSI signal, as in the case of solubility determination experiments.

### 4.2 Analytes

The assays of this invention are useful for determining interaction of various kinds of analytes. Analytes that one can test include, without limitation, small organic molecules, biopolymers, macromolecular complexes, viruses, serum, cell lysates, membrane preparations and cells.

Accordingly, the interactions can be between antibody-antigen, protein-protein, small molecule-small molecule; small molecule-protein, drug-receptor; antibody-cell; protein-cell; oligonucleotide-cell; carbohydrate-cell; cell-cell; enzyme-substrate; protein-DNA; protein-aptamer; DNA-DNA; RNA-RNA; DNA-RNA; protein-RNA; small molecule-nucleic acid; biomolecule-molecular imprint; biomolecule-protein mimetic; biomolecule-antibody derivatives; lectin-carbohydrate; biomolecule-carbohydrate; small molecule-micelle; small molecule-cell membrane-bound protein; antibody-cell membrane-bound protein; or enzyme-substrate. In another embodiment, the agent can be an enzyme or enzyme complex (mixture) which catalyzes an enzymatic reaction which can degrade sample components such as cells, cell fragments, and/or biomolecules. In another embodiment the agent could be an enzyme or enzyme complex (mixture) which catalyzes the creation of new biomolecules arising from the fusion of biomolecular species (such as a ligase) or replication/amplification of biomolecular species, as is the case in polymerase chain reactions.

Drug candidates useful as analytes in this invention include small organic molecules and biological molecules, e.g., biologics. Organic molecules used as pharmaceuticals generally are small organic molecules typically having a size up to about 500 Da, up to about 2000 Da, or up to about 10000 Da. Certain hormones are small organic molecules.

Organic biopolymers also are used as analytes. These include, for example, polypeptides (e.g., peptides and proteins), polynucleotides (e.g., oligonucleotides or nucleic acids), carbohydrates, lipids and molecules that combine these, for example glycoproteins, glycolipids and lipoproteins. Certain hormones are biopolymers. Antibodies find increasing use as biological pharmaceuticals. U.S. publication 2009-0035216 provides a list of antibody drugs. This list includes, for example herceptin, bevacizumab, avastin, erbitux and synagis (cell adhesion molecules).

Macromolecular complexes also can be used as analytes. They are typically at least 500K Da in size. They include, for example, membrane complexes that are macromolecular assemblies like ion channels and pumps (e.g., Na—K pumps), ATP-ases, secretases, nucleic acid-protein complexes, polyribosomal complexes, polysomes, the p450 complex, photosystem I complex and enzyme complexes associated with electron transport size.

Viruses and parts of viruses e.g., capsids and coat proteins, also can be analytes. Cells can be analytes. In this way, for example, cell surface molecules, such as adhesion factors, can be tested. Cells can be, for example, pathogens, cancer cells, inflammatory cells, t-cells, b-cells, NK cells, macrophages, etc.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A method of detecting an analyte in a solution comprising:
detecting interaction between the analyte and a binding partner by back-scattering interferometry (BSI),
wherein the binding partner is associated with a nanoparticle (“binding partner-nanoparticle combination”).

2. The method of claim 1 wherein the analyte and the binding partner-nanoparticle combination are in free-solution.

3. The method of claim 1 wherein the analyte or the binding partner-nanoparticle combination is immobilized on a wall of an assay compartment.

4. (canceled)

5. The method of claim 1 wherein the method comprises an end-point assay or a kinetic assay.

6. (canceled)

7. The method of claim 1 wherein back-scattering interferometry uses a laser emitting light having a wavelength in the visible or near-infrared range, and the nanoparticle in its longest dimension has a length between one-tenth and one-half of the wavelength.

8. The method of claim 7 wherein the laser is a helium neon (HeNe) laser, VCSEL or LED laser or the laser emits light at about 543 nm, about 632.8 nm, about 1.15 μm, about 1.52 μm, or about 3.39 μm.

9. (canceled)

10. The method of claim 1 wherein the nanoparticle, in its longest dimension, has a length between 1 nm and 1 micron.

11. The method of claim 1 wherein the nanoparticle, in its longest dimension, has a length between about 60 nm and about 300 nm.

12. The method of claim 1 wherein the nanoparticle is characterized by one or more of:
is spheroid;
is discoid;
comprises a metal, a ceramic, a polymer, or a macromolecular structure;
comprises a rare earth metal;
comprises silver or gold;
comprises silica;
comprises latex;
is selected from a liposome, a lipoparticle, an amphipol, a nanodiscs and a fluorinated surfactant;
is not a liposome;
comprises a small unilamellar vesicle; and
comprises a large unilamellar vesicle.

13-21. (canceled)

22. The method of claim 1 wherein the binding partner is characterized by one or more of:
is associated with a surface of the nanoparticle:
is associated within the nanoparticle;
is covalently bound to the nanoparticle;
is non-covalently bound to the nanoparticle;
comprises a small molecule, a nucleic acid, a polypeptide, a carbohydrate, a lipid, protein, glycoprotein, lipoprotein, DNA, RNA, DNA-protein construct or an RNA-protein construct;
comprises a small molecule, a nucleic acid, a polypeptide, a carbohydrate, a lipid, protein, glycoprotein, lipoprotein, DNA, RNA, DNA-protein construct or an RNA-protein construct;
comprises a membrane protein; and
comprises a membrane protein associated with lipid comprised in the nanoparticle.

23-25. (canceled)

26. The method of claim 1 wherein the interaction is between antibody-antigen, protein-protein, small molecule-small molecule; small molecule-protein, drug-receptor; enzyme-substrate; protein-DNA; protein-aptamer; DNA-DNA; RNA-RNA; DNA-RNA; protein-RNA; small molecule-nucleic acid; biomolecule-molecular imprint; biomolecule-protein mimetic; biomolecule-antibody derivatives; lectin-carbohydrate; biomolecule-carbohydrate; small molecule-cell membrane-bound protein; antibody-cell membrane-bound protein; or enzyme-substrate.

27. The method of claim 1 wherein the analyte comprises a small molecule, a nucleic acid, a polypeptide, a carbohydrate, a lipid, protein, glycoprotein, lipoprotein, DNA, RNA, DNA-protein construct or an RNA-protein construct.

28-30. (canceled)

31. The method of claim 1 wherein the concentration of the analyte is less than 1.0×10-5 M, less than 1.0×10-6 M, less than 1.0×10-7 M, less than 1.0×10-8 M, less than 1.0×10-9 M, less than 1.0×10-10 M, less than 1.0×10-11 M or less than 1.0×10-12 M.

32. (canceled)

33. A method comprising:
(a) providing an instrument comprising:
(i) a coherent light source;
(ii) a container comprising a compartment comprising an interrogation volume positioned to be interrogated by coherent light from the coherent light source, wherein the interrogation volume is configured to generate back-scattered light comprising an interference fringe pattern when interrogated by the coherent light source; and
(iii) a detector to detect the back-scattered light;
(b) placing a binding partner into the compartment
(c) placing an analyte into the compartment;
(d) interrogating the compartment with coherent light from the coherent light source; and
(e) detecting interaction between the analyte and the binding partner based on the generated interference fringe pattern.

34. The method of claim 33 wherein detecting binding comprises detecting back-scattered light from the channel, converting the detected back-scattered light into a measure of refractive index and correlating the measure with a measure indicating binding.

35. The method of claim 33 further comprising one of:
(I) the analyte and the binding partner are placed into the compartment in free solution, and the binding partner is associated with a nanoparticle;
(II) the binding partner is immobilized on a wall of the compartment and the analyte is associated with a nanoparticle when placed into the compartment;
(III) the binding partner is immobilized on a wall of the compartment and the analyte is bound to a nanoparticle when placed into the compartment; or
(IV) the binding partner is associated with a nanoparticle and is immobilized on a wall of the compartment.

36-39. (canceled)

40. The method of claim 33 further comprising
(f) introducing a test agent into the compartment prior to the interrogating;
(g) determining whether the test agent alters binding between the analyte and the binding partner based on the generated interference fringe pattern.

41. (canceled)

42. An instrument comprising:
(a) a coherent light source;
(b) a container comprising a compartment comprising an interrogation volume positioned to be interrogated by coherent light from the coherent light source, wherein the interrogation volume is configured to generate back-scattered light comprising an interference fringe pattern when interrogated by the coherent light source, and wherein the compartment comprises a solution comprising a binding partner associated with a nanoparticle; and
(c) a detector to detect the back-scattered light.

43. The instrument of claim 42 further comprising:
(d) a signal analyzer configured to analyze a signal provided by the detector.

44. The instrument of claim 42 wherein the coherent light source is a HeNe laser, VCSEL or LED laser.
